(19) United States
(12) Patent Application Publication
(10) Pub. No.: US 2026/0328188 A1
(43) Pub. Date: Oct. 22, 2026

(54) TOWER OF A WIND TURBINE

(71) Applicants: NORDEX ENERGY SE & CO. KG, Hamburg (DE); NORDEX ENERGY SPAIN, S.A.U., NAVARRA (ES)

(72) Inventors: Iván GARCÍA MAESTRE, NAVARRA (ES); Aitor GARDUÑO, NAVARRA (ES); Fernando VARELA, NAVARRA (ES); Miguel GONZALEZ, NAVARRA (ES); Iñigo RUBIO GUILLEN, NAVARRA (ES); Teresa ARLABAN, NAVARRA (ES)

(21) Appl. No.: 19/116,014

(22) PCT Filed: Sep. 27, 2023
(86) PCT No.: PCT/EP2023/076691

§ 371 Date: Mar. 27, 2025

(30) Foreign Application Priority Data
Sep. 27, 2022 (EP) 22382884.9
Sep. 27, 2022 (EP) 22382885.6
Jun. 21, 2023 (EP) 23382633.8

(51) Int. Cl. F03D 13/20; E04H 12/08; E04H 12/12

(52) U.S. Cl. CPC F03D 13/205; E04H 12/085; E04H 12/12; F05B 2230/60; F05B 2240/912

(57) ABSTRACT

The object of the invention is a wind turbine tower which reinforces the upper part of the section of the tower of the wind turbine, wherein the tower comprises—at least one first tower section;—an adapter disposed between the at least one first tower section and at least one second tower section or a wind turbine component, wherein the at least one first tower section is a concrete tower section comprising an upper flange comprising an external diameter; and wherein the adapter comprises:—a lower flange configured to join the adapter to the at least one first tower section; wherein the lower flange of the adapter comprises an external diameter.

### OBJECT OF THE INVENTION

The object of the invention is a tower of a wind turbine.

### BACKGROUND OF THE INVENTION

The wind turbines comprise a tower, a nacelle which houses the electrical generator and a rotor formed in turn by at least two blades. The tower of the wind turbine supports the nacelle and the rotor. Large wind turbines have steel, lattice, or reinforced concrete towers or even mixed-type towers, the latter comprising sections of different materials, for example, a lower section of concrete and an upper section of steel or lattice.

Due to the height of the wind turbines, the tower has to be divided into several annular sections which are stacked during the wind turbine assembly stage thus forming the full height of the tower. Dividing the tower into sections has the advantage that each section has a size such that its transport by road or rail is easier.

One of the most commonly used materials for large towers is concrete, since it involves competitive costs and performance compared to those to produce steel towers of similar characteristics. However, the weight of each concrete tower section can easily exceed one hundred tons, this fact being infrequent for metal tower sections, so stacking the concrete sections requires heavy-tonnage lifting and positioning means. The cost of using such lifting and positioning means, which may be for example a crane, is directly related to the tonnage and height that it is capable of handling and the time of use thereof. This high-tonnage crane is also used for lifting and positioning the nacelle, as the weight of the nacelle may also exceed 100 tons.

It is known in the state of the art, the towers for wind turbines being of the kind of “concrete-steel hybrid” towers comprising a first tower section comprising at least two concrete segments and further comprising a second tower section made of steel, the tower further comprising an adapter for connecting the two tower sections, and the towers for wind turbines being of the kind of “full-concrete” towers comprising an adapter disposed in the upper part of the upper concrete tower section and below a wind turbine component, the wind turbine component being preferably the yaw bearing of the nacelle.

In a first embodiment, the adapter comprises an annular concrete element and a steel element that has at least one annular flange, wherein the flange covers an upper surface of the concrete element of the adapter in installation position. Consequently, this adapter consists of concrete and steel, in which case the steel element is cast directly with the concrete element of the adapter. Here, the annular flange of the steel element is fully grouted in the concrete without air inclusions. In a related method for building the tower, the steel element with an annular flange is initially provided for building the adapter, which is installed headlong in a ring-shaped formwork. Afterwards, concrete is placed in the formwork and as a result of that, the annular concrete element of the adapter can be made. Here, the concrete is placed directly on the underside of the flange so that, in the finished adapter, the flange is fully grouted establishing a connection between the concrete element and the steel element of the adapter.

In a second embodiment, the adapter is made entirely of steel, and a grout layer must be disposed between the adapter and the first tower section made of concrete to establish a connection between the steel adapter and the concrete section.

However, in both embodiments, the adapter is joined to the immediately below concrete part or section by means of bolts passing through a first set of holes. The adapter may also comprise a second set of holes for allowing the passage of tensioning elements of the tower. The first set of holes and the second set of holes are disposed in concentrical circumferences with different radius, thus needing more material and complex system for attaching auxiliary devices of the tower or thus resulting in technical solutions wherein the disposition of the tensioning elements far from the inner tower wall not carrying out an optimum post-tensioning of the concrete wall.

Currently, some wind turbine towers with concrete segments include a geometry of the adapter which comprises a concrete part comprising an inward thickness increase towards the inside of the tower with respect to the wall thickness in a central part of the concrete part and a steel part. This inward thickness increase towards the inside of the tower is necessary for providing a wider contact area for the concrete-grout (or concrete-resin) interfaces in the horizontal joint between the concrete part and the steel part of the adapter so that the stresses can be stood by the filler material (grout or resin) used in the horizontal joints, allowing for some manufacturing or pouring deficiencies of such filler material.

However, this state-of-the-art geometry gives rise to undesirable local effects in the concrete segments, such as:
Local bending moments in transition region from the central part and the connection area of the concrete part that increase concrete compressive stresses and that require additional reinforcement for tensile forces at the beginning of the connection area; and
Circumferential compressive and tensile stresses close to thickness changes.

The present invention solves the problems described above.

### DESCRIPTION OF THE INVENTION

The invention relates to a tower of a wind turbine comprising:
at least one first tower section;
an adapter disposed between the at least one first tower section and at least one second tower section or a wind turbine component,
wherein the at least one first tower section is a concrete tower section comprising an upper flange comprising an external diameter; and
wherein the adapter comprises
a lower flange configured to join the adapter to the upper flange of the at least one first tower section;
wherein the lower flange of the adapter comprises an external diameter;
wherein the external diameter of the upper flange of the at least one first tower section is greater than the external diameter of the lower flange of the adapter.

In this way, the tower so constituted allows to distribute the loads of the elements disposed above the adapter in a uniform way along the thickness of the tower comprising the at least one first tower section

Moreover, this disposition of the adapter with respect to the at least one first tower section allows to gain access to the upper flange of the at least one first tower section once the adapter is disposed onto the at least one first tower section. This makes possible to carry out different operations on the upper flange of the at least one first tower even if the adapter is disposed onto the at least one first tower section.

Optionally, the upper flange of the at least one first tower section comprises:
a first set of holes intended to accommodate, in use, the plurality of tensioning elements; and
a second set of holes intended accommodate, in use, the plurality of bolts.

Optionally, the first set of holes and the second set of holes are disposed in a single circumferential row.

Optionally, the lower flange of the adapter comprises:
a first set of holes intended to accommodate, in use, the plurality of tensioning elements; and
a second set of holes intended accommodate, in use, the plurality of bolts.

Optionally, the first set of holes and the second set of holes are disposed in a single circumferential row.

Optionally, the at least one first tower section comprises at least one concrete segment which in turn comprises:
a central area comprising an inner surface and an outer surface located below the upper flange of the at least one first tower section, and an imaginary central surface located at the same distance from the inner surface as from the outer surface;
   wherein a vertical projection of a circumference defined by the external diameter of the lower flange of the adapter intersects with the imaginary central surface.

In this way, a load path coming from the upper part of the tower, above the adapter, and intended to be transmitted along the central area, is transmitted by the imaginary central surface.

Optionally, the vertical projection of the circumference defined by the external diameter of the lower flange of the adapter further intersects with the outer surface of the at least one concrete segment in an upper end of the central area.

Optionally, the adapter further comprises a central portion joined to the lower flange, wherein both of the central portion and the lower flange comprises an inner surface, wherein the imaginary central surface intersects with the inner surface.

Optionally, the imaginary central surface intersects with the inner surface in a vicinity of the lower flange.

So, the tower has an inner adapter-free area above the upper flange of the adapter that allows to gain access to the inner part of the upper flange of the at least one first tower section once the adapter is disposed onto the at least one first tower section to carry out different operations on the upper flange of the at least one first tower even if the adapter is disposed onto the at least one first tower section, e.g., a leveling step using grout.

Optionally, the inner surface of the central area comprises an internal diameter, wherein the external diameter of the lower flange of the adapter is smaller than the internal diameter of the inner surface of the central area of the at least one concrete segment.

Optionally, the lower flange of the adapter comprises an internal diameter and the upper flange of the at least one first tower section comprises an internal diameter, wherein an offset between the external diameter of the upper flange of the at least one first tower section and the external diameter of the lower flange of the adapter is substantially the same that an offset between the internal diameter of the lower flange of the adapter and the internal diameter of the upper flange of the at least one first tower section.

So, the lower flange of the adapter is substantially centered within the upper flange of the at least one first tower section.

Optionally, the central area of the at least one concrete segment of the at least one first tower section comprises a first wall thickness defined as the distance between the inner surface and the outer surface; and

wherein the at least one concrete segment of the at least one first tower section comprises:
at least one upper connection area comprising the upper flange, wherein the at least one upper connection area is configured to be connected to the adapter by means of the upper flange, wherein the at least one upper connection area comprises a second wall thickness being bigger than the first wall thickness.

Optionally, the second wall thickness comprises an inward thickness increase with respect to the first wall thickness.

Optionally, the second wall thickness comprises an outward thickness increase with respect to the first wall thickness.

Optionally, the outer surface of the central area comprises a first slope with regard to the central surface and the outward thickness increase of the second wall thickness comprises at least one oblique part which in turn comprises a second slope with regard to the central surface, wherein the second slope is greater that the first slope.

Optionally, a projection of the outer surface of the central area of the at least one concrete segment at a height wherein the lower flange of the adapter is disposed, substantially coincides with the external diameter of the adapter.

Optionally, the tower further comprises joining elements configured to join the adapter to the at least one first tower section, preferably bolts and nuts.

Optionally, the joining means further comprises tensioning elements also configured to tension the tower.

Optionally, the joining means comprises an axis, wherein the upper flange of the at least one first concrete section comprises an inner third, a central third and an outer third, wherein the axis of the joining means goes through the upper flange of the at least one first concrete section in the central third.

Optionally, the tower comprises a central vertical axis and each of the joining means comprises an axis, wherein the axis of the joining means or its projection is closer to the central vertical axis than the inner surface of the central area.

Optionally, the adapter further comprises an upper flange configured to join the adapter to the at least one second tower section or to the wind turbine component.

### DESCRIPTION OF THE FIGURES

To complement the description being made and for the sake of a better understanding of the characteristics of the invention according to a preferred practical embodiment thereof, attached as an integral part of said description are a set of drawings wherein, for the purpose of illustration and not limiting the scope of the invention, the following is shown:

FIG. 1 shows an elevation view of a tower of a wind turbine comprising an adapter according to the invention and a concrete section according to the invention.

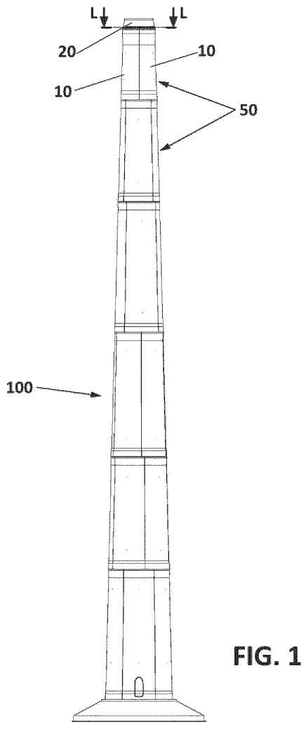

FIG. 2 shows a detail of section view LL of the tower of FIG. 1 according to a first embodiment, wherein the adapter has been partially deleted to shown the upper flange of the concrete section of the tower.

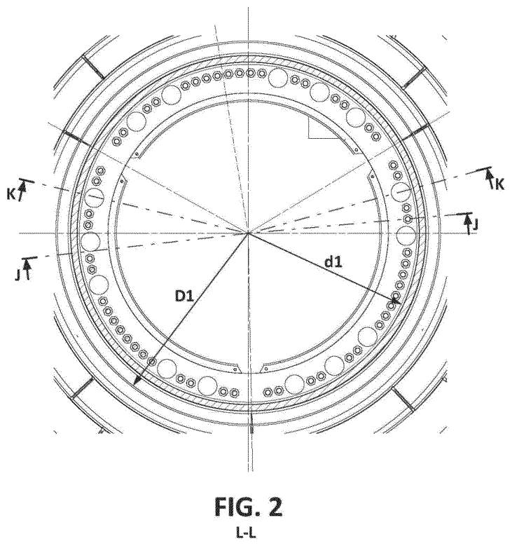

FIG. 3 shows a section view JJ of FIG. 2.

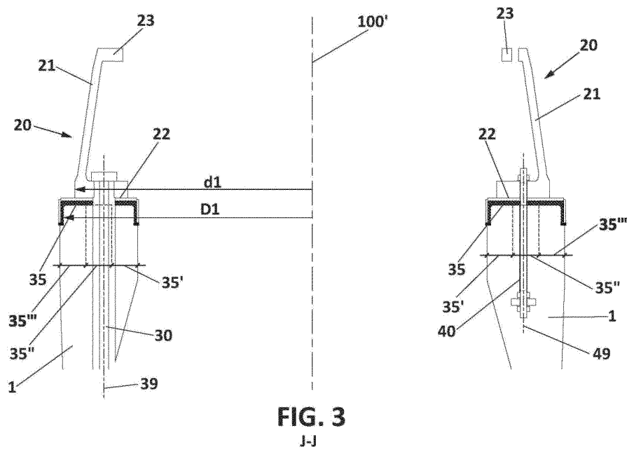

FIG. 4 shows a partial section view KK of FIG. 2.

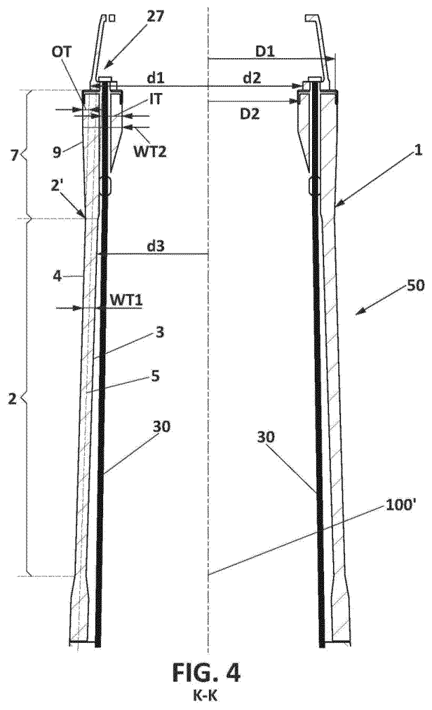

### PREFERRED EMBODIMENT OF THE INVENTION

The following is a detailed description of the tower of the wind turbine, wherein the tower (100) comprises:
at least one first tower section (50);
an adapter (20) disposed between the at least one first tower section (50) and at least one second tower section or a wind turbine component,
wherein the at least one first tower section (50) is a concrete tower section comprising an upper flange (35) comprising an external diameter (D1); and
wherein the adapter (20) comprises:
a central portion (21);
a lower flange (22) configured to join the adapter (20) to the upper flange (35) of the at least one first tower section (50);
an upper flange (23) configured to join the adapter (20) to the at least one second tower section or to the wind turbine component.
wherein the lower flange (22) of the adapter (20) comprises an external diameter (d1); and
wherein the external diameter (D1) of the upper flange (35) of the at least one first tower section (50) is greater than the external diameter (d1) of the lower flange (22) of the adapter (20).

The at least one first tower section (50) comprises at least one concrete segment (1) which in turn comprises:
a central area (2) comprising an inner surface (3) and an outer surface (4) located below the upper flange (35) of the at least one first tower section (50), and an imaginary central surface (5) located at the same distance from the inner surface (3) as from the outer surface (4);
   wherein a vertical projection of a circumference defined by the external diameter (d1) of the lower flange (22) of the adapter (20) intersects with the imaginary central surface (5).

The vertical projection of the circumference defined by the external diameter (d1) of the lower flange (22) of the adapter (20) further intersects with the outer surface (4) of the at least one concrete segment (1) in an upper end (2′) of the central area (2).

The adapter (20) further comprises a central portion (21) joined to the lower flange (22), wherein both of the central portion (21) and the lower flange (22) comprises an inner surface (27), wherein the imaginary central surface (5) intersects with the inner surface (27), preferably in a vicinity of the lower flange (22).

The inner surface (3) of the central area (2) comprises an internal diameter (d3), wherein the external diameter (d1) of the lower flange (22) of the adapter (20) is smaller than the internal diameter (D3) of the inner surface (3) of the central area (2) of the at least one concrete segment (1), preferably in a lower part of the central area (2) of the at least one concrete segment (1).

In this embodiment, the lower flange (22) of the adapter (20) comprises an internal diameter (d2) and the upper flange (35) of the at least one first tower section (50) comprises an internal diameter (D2), wherein an offset between the external diameter (D1) of the upper flange (35) of the at least one first tower section (50) and the external diameter (d1) of the lower flange (22) of the adapter (20) is substantially the same that an offset between the internal diameter (d2) of the lower flange (22) of the adapter (20) and the internal diameter (D2) of the upper flange (35) of the at least one first tower section (50).

Preferably, a ratio between the internal diameter (d2) of the lower flange (22) of the adapter (20) and the internal diameter (D2) of the upper flange (35) of the at least one first tower section (50), and the offset between the external diameter (D1) of the upper flange (35) of the at least one first tower section (50) and the external diameter (d1) of the lower flange (22) of the adapter (20), is between 0.5 and 0.7.

The central area (2) of the at least one concrete segment (1) of the at least one first tower section (50) comprises a first wall thickness (WT1) defined as the distance between the inner surface (3) and the outer surface (4); and

wherein the at least one concrete segment (1) of the at least one first tower section (50) comprises:
at least one upper connection area (7) comprising the upper flange (35), wherein the at least one upper connection area (7) is configured to be connected to the adapter (20) by means of the upper flange (35), wherein the at least one upper connection area (7) comprises a second wall thickness (WT2) being bigger than the first wall thickness (WT1),
wherein the second wall thickness (WT2) comprises an inward thickness increase (IT) with respect to the first wall thickness (WT1),
wherein the second wall thickness (WT2) comprises an outward thickness increase (OT) with respect to the first wall thickness (WT1).

In this embodiment, the outer surface (4) of the central area (2) comprises a first slope with regard to the central surface (5) and the outward thickness increase (OT) of the second wall thickness (WT2) comprises at least one oblique part (9) which in turn comprises a second slope with regard to the central surface (5), wherein the second slope is greater that the first slope.

In this embodiment, a projection of the outer surface (4) of the central area (2) of the at least one concrete segment (1) at a height wherein the lower flange (22) of the adapter (20) is disposed, substantially coincides with the external diameter (d1) of the adapter (20).

The tower (100) further comprises joining elements (30, 40) configured to join the adapter (20) to the at least one first tower section (50), wherein the joining means (30, 40) comprises tensioning elements (30) also configured to tension the tower and/or bolts (40) configured to join the adapter (20) to the at least one first concrete section (50).

In this embodiment, each one of the joining means (30, 40) comprises an axis (39, 49), wherein the upper flange (35) of the at least one first concrete section (50) comprises an inner third (35′), a central third (35″) and an outer third (35″), wherein the axis (39, 49) of the joining means (30, 40) goes through the upper flange (35) of the at least one first concrete section (50) in the central third (35″).

The tower (100) comprises a central vertical axis (100′) and the joining means (30, 40) comprises an axis (39, 49), wherein the axis (39, 49) of the joining means (30, 40) or its projection is closer to the central vertical axis (100′) than the inner surface (3) of the central area (2).

1. Tower (100) of a wind turbine comprising:
at least one first tower section (50);
an adapter (20) disposed between the at least one first tower section (50) and at least one second tower section or a wind turbine component,
wherein the at least one first tower section (50) is a concrete tower section comprising an upper flange (35) comprising an external diameter (D1); and
wherein the adapter (20) comprises:
a lower flange (22) configured to join the adapter (20) to the upper flange (35) of the at least one first tower section (50);
wherein the lower flange (22) of the adapter (20) comprises an external diameter (d1);
characterised in that the external diameter (D1) of the upper flange (35) of the at least one first tower section (50) is greater than the external diameter (d1) of the lower flange (22) of the adapter (20).

2. The tower (100) of claim 1, wherein the at least one first tower section (50) comprises at least one concrete segment (1) which in turn comprises:
a central area (2) comprising an inner surface (3) and an outer surface (4) located below the upper flange (35) of the at least one first tower section (50), and an imaginary central surface (5) located at the same distance from the inner surface (3) as from the outer surface (4);
wherein a vertical projection of a circumference defined by the external diameter (d1) of the lower flange (22) of the adapter (20) intersects with the imaginary central surface (5).

3. The tower (100) of claim 2, wherein the vertical projection of the circumference defined by the external diameter (d1) of the lower flange (22) of the adapter (20) further intersects with the outer surface (4) of the at least one concrete segment (1) in an upper end (2′) of the central area (2).

4. The tower (100) of any of claims 2 or 3, wherein the adapter (20) further comprises a central portion (21) joined to the lower flange (22), wherein both of the central portion (21) and the lower flange (22) comprises an inner surface (27), wherein the imaginary central surface (5) intersects with the inner surface (27).

5. The tower (100) of claim 4, wherein the imaginary central surface (5) intersects with the inner surface (27) in a vicinity of the lower flange (22).

6. The tower (100) of any of previous claims, wherein the inner surface (3) of the central area (2) comprises an internal diameter (d3), wherein the external diameter (d1) of the lower flange (22) of the adapter (20) is smaller than the internal diameter (D3) of the inner surface (3) of the central area (2) of the at least one concrete segment (1).

7. The tower (100) of any of previous claims, wherein the lower flange (22) of the adapter (20) comprises an internal diameter (d2) and the upper flange (35) of the at least one first tower section (50) comprises an internal diameter (D2), wherein an offset between the external diameter (D1) of the upper flange (35) of the at least one first tower section (50) and the external diameter (d1) of the lower flange (22) of the adapter (20) is substantially the same that an offset between the internal diameter (d2) of the lower flange (22) of the adapter (20) and the internal diameter (D2) of the upper flange (35) of the at least one first tower section (50).

8. The tower (100) of claims 2 to 5, wherein the central area (2) of the at least one concrete segment (1) of the at least one first tower section (50) comprises a first wall thickness (WT1) defined as the distance between the inner surface (3) and the outer surface (4); and
wherein the at least one concrete segment (1) of the at least one first tower section (50) comprises:
at least one upper connection area (7) comprising the upper flange (35), wherein the at least one upper connection area (7) is configured to be connected to the adapter (20) by means of the upper flange (35), wherein the at least one upper connection area (7) comprises a second wall thickness (WT2) being bigger than the first wall thickness (WT1).

9. The tower (100) of claim 8, wherein the second wall thickness (WT2) comprises an inward thickness increase (IT) with respect to the first wall thickness (WT1).

10. The tower (100) of any of claims 8 or 9, wherein the second wall thickness (WT2) comprises an outward thickness increase (OT) with respect to the first wall thickness (WT1).

11. The tower (100) of claim 10, wherein the outer surface (4) of the central area (2) comprises a first slope with regard to the central surface (5) and the outward thickness increase (OT) of the second wall thickness (WT2) comprises at least one oblique part (9) which in turn comprises a second slope with regard to the central surface (5), wherein the second slope is greater that the first slope.

12. The tower (100) of claims 2 to 5, wherein a projection of the outer surface (4) of the central area (2) of the at least one concrete segment (1) at a height wherein the lower flange (22) of the adapter (20) is disposed, substantially coincides with the external diameter (d1) of the adapter (20).

13. The tower (100) of any of previous claims, further comprising joining elements (30, 40) configured to join the adapter (20) to the at least one first tower section (50).

14. The tower (100) of claim 13, wherein each of the joining means (30, 40) comprises tensioning elements (30) also configured to tension the tower and/or bolts (40) configured to join the adapter (20) to the at least one first concrete section (50).

15. The tower (100) of any of claims 13 or 14, wherein the joining means (30, 40) comprises an axis (39, 49), wherein the upper flange (35) of the at least one first concrete section (50) comprises an inner third (35′), a central third (35″) and an outer third (35″), wherein the axis (39, 49) of the joining means (30, 40) goes through the upper flange (35) of the at least one first concrete section (50) in the central third (35″).

16. The tower (100) of any of claims 13 or 14 and any of claims 2 to 5, wherein the tower (100) comprises a central vertical axis (100′) and each of the joining means (30, 40) comprise an axis (39, 49), wherein the axis (39, 49) of the joining means (30, 40) or its projection is closer to the central vertical axis (100′) than the inner surface (3) of the central area (2).

17. The tower (100) of any of previous claims wherein the adapter (20) further comprises:
an upper flange (23) configured to join the adapter (20) to the at least one second tower section or to the wind turbine component.
